(19) United States
(12) Patent Application Publication
(10) Pub. No.: US 2005/0110413 A1
(43) Pub. Date: May 26, 2005

(54) Method for producing an electric lamp, and an electric lamp

(75) Inventors: Christine Maier, Herbrechtingen (DE); Roland Mayer, Giengen (DE)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Patent-Treuhand-Gesellschaft fur elektrische Gluhlampen mbH, Munchen (DE)

(21) Appl. No.: 10/992,256

(22) Filed: Nov. 17, 2004

(30) Foreign Application Priority Data
Nov. 24, 2003 (DE) 10355101.8

(51) Int. Cl. H01J 61/36

(52) U.S. Cl. 313/626

(57) ABSTRACT

The invention relates to a production method for an electric lamp and a corresponding lamp. According to the invention, during the production method, a prefabricated glass/metal composite (3) acting as a lamp vessel seal is provided, from which the power supply lines (1, 2) for the at least one luminous element (5) protrude, the at least one luminous element (5) being connected to its power supply lines (1, 2) during a first method step, and the lamp vessel (6) being turned up over the at least one luminous element (5) and connected to the glass/metal composite (3) during a second method step following on from the first method step.

The invention relates to a method for producing an electric lamp in accordance with the preamble of patent claim 1 and to an electric lamp.

I. Prior Art

The laid-open specification WO 96/05610 and the patent specification U.S. Pat. No. 5,339,002 disclose headlights for motor vehicles and a production method for these lamps. According to the laid-open specification WO 96/05610, a completely prefabricated lamp vessel, which is sealed in a gas-tight manner and has incandescent filaments arranged therein, is mounted in a metallic base part. The patent specification U.S. Pat. No. 5,339,002 also describes the adjustment of the incandescent filament when mounting the lamp base according to the so-called 5-axis adjustment. With 5-axis adjustment, in order to align the incandescent filament with respect to the lamp base, the unit comprising the completely prefabricated lamp vessel, including the incandescent filament enclosed therein, and a base part acting as the holder for the lamp vessel is aligned with respect to a reference plane of the lamp base. For this purpose, the lamp base is composed of two or more base parts, whose mutual position is altered in order to adjust the incandescent filament until the incandescent filament has the desired alignment, and said base parts are then fixed in this position.

II. Summary of the Invention

The object of the invention is to provide an improved production method for electric lamps, which makes it possible, in particular, in a simple manner to mount and align the luminous element, and to provide corresponding lamps.

This object is achieved according to the invention by the features of patent claims 1 and 9, respectively. Particularly advantageous embodiments of the invention are described in the dependent patent claims.

The production method according to the invention for electric lamps is characterized in that, during the production method, a prefabricated glass/metal composite acting as the lamp vessel seal is provided, from which power supply lines for at least one luminous element protrude, the at least one luminous element being connected to its power supply lines during a first method step, and the lamp vessel being turned up over the at least one luminous element and connected to the glass/metal composite during a second method step following on from the first method step.

Owing to the separate manufacture of the glass/metal composite acting as the lamp vessel seal and the lamp vessel surrounding the luminous element, the ends of the power supply lines remain freely accessible for the purpose of holding the at least one luminous element when mounting the luminous element. The at least one luminous element may thus be mounted when the lamp vessel is still open. This simplifies the alignment and mounting of the luminous elements.

The lamp vessel and the glass/metal composite acting as the lamp vessel seal are preferably fused to one another for the purpose of connecting them in order to ensure a gas-tight connection which may be subjected to a high thermal load. The two abovementioned components are preferably fused by means of a LASER which makes possible locally limited heating of the lamp vessel and the glass/metal composite in the connection region, with the result that the embedding of the power supply lines in the glass/metal composite is not impaired by the heating. In order to eliminate any mechanical stresses which result owing to the fusing of the lamp vessel and the glass/metal composite, at least the connection region between the two abovementioned lamp parts is advantageously subjected to heat treatment.

In order to be able to produce an appropriate connection to the lamp vessel, which is generally an axially symmetrical or rotationally symmetrical hollow body, one end of the glass/metal composite is advantageously provided with a tubular attachment when the glass/metal composite is produced. The dimensions of this tubular attachment transverse to the lamp axis are preferably matched to the corresponding dimensions of the lamp vessel. The connection region between the lamp vessel and the glass/metal composite should have as large a spacing as possible from the at least one luminous element in order to largely rule out the light emission being disrupted by parasitic light. The connection region between the lamp vessel and the glass/metal composite should therefore be arranged as near to the lamp base as possible or should even be inserted in the lamp base. For manufacturing the glass/metal composite, a glass tube is therefore preferably used which has a smaller outer diameter than the lamp vessel, and the tubular attachment of the glass/metal composite is widened conically for connection to the lamp vessel. As a result, the connection region between the lamp vessel and the glass/metal composite can be arranged near to where the power supply lines are embedded in the glass/metal composite, and a sufficiently large spacing from the luminous elements is achieved.

It is particularly advantageous that the method according to the invention can be used in combination with a glass/metal composite which is produced from a glass tube by the metallic power supply lines being passed through the glass tube, and then a section of the glass tube being softened by heating, and the power supply lines being embedded in the glass by pinching the softened glass. As a result, the glass/metal composite provided as the lamp vessel seal is already optimally matched to the geometry of the lamp vessel. In particular, the tubular attachment, which serves the purpose of connecting it to the lamp vessel, need not be produced separately but is already provided owing to the geometry of the glass tube.

The production method according to the invention offers particularly significant advantages in the manufacture of electric lamps whose luminous elements need to be adjusted with respect to a lamp base or a lamp base part acting as the reference. In contrast to the above-described prior art in which, in order to adjust the luminous element, the completely prefabricated lamp vessel, including the luminous element enclosed therein, needs to be aligned with respect to a reference plane of the lamp base by means of two or more lamp base parts, in accordance with the production method according to the invention, the at least one luminous element is adjusted with respect to the lamp base advantageously when it is mounted on its power supply lines. For this purpose, the lamp base part acting as the reference for the adjustment of the at least one luminous element is mounted on the lamp vessel seal provided with its power supply lines even before the at least one luminous element is mounted. In addition, the lamp vessel and its lamp vessel seal provided with the power supply lines are formed as separate components which are not fused to one another until after the at least one luminous element has been aligned and mounted, in order for the at least one luminous element and the ends of its power supply lines to remain accessible for the adjustment and mounting of the at least one luminous element. The at least one luminous element is thus advantageously adjusted with respect to the lamp base directly when the at least one luminous element is mounted on its power supply lines. As a result, the comparatively complex 5-axis adjustment according to the above-cited prior art is superfluous. In particular, the reference plane defined by the lamp base part for the at least one luminous element is maintained throughout the manufacturing process of the lamp. This reference plane may therefore also be used for accurately aligning the at least one luminous element in an optical system, for example in a headlight. The at least one luminous element is, in the case of an incandescent lamp, an incandescent filament and, in the case of a gas-discharge lamp, the electrodes of the lamp, between which the gas discharge is formed during lamp operation.

The electric lamp according to the invention has at least one luminous element which is surrounded by a lamp vessel, the lamp vessel being provided with a lamp vessel seal, through which power supply lines for the at least one luminous element are passed. According to the invention, the lamp vessel and the lamp vessel seal are formed as separate lamp components which are joined by connection means. The fact that the lamp vessel and the lamp vessel seal are separated in this manner makes it possible to adjust and mount, in a simple manner, the at least one luminous element on its power supply lines, since the ends of the power supply lines and the at least one luminous element are meanwhile not surrounded by the lamp vessel but are freely accessible.

The lamp vessel seal is advantageously in the form of a pinch seal, which preferably comprises either metal foil embedding in silica glass or metal wire embedding in hard glass, the metal foils embedded in the silica glass or the metal wires embedded in the hard glass being part of the power supply lines.

### III. DESCRIPTION OF THE PREFERRED EXEMPLARY EMBODIMENT

The invention will be explained in more detail below with reference to a preferred exemplary embodiment. In the drawings:

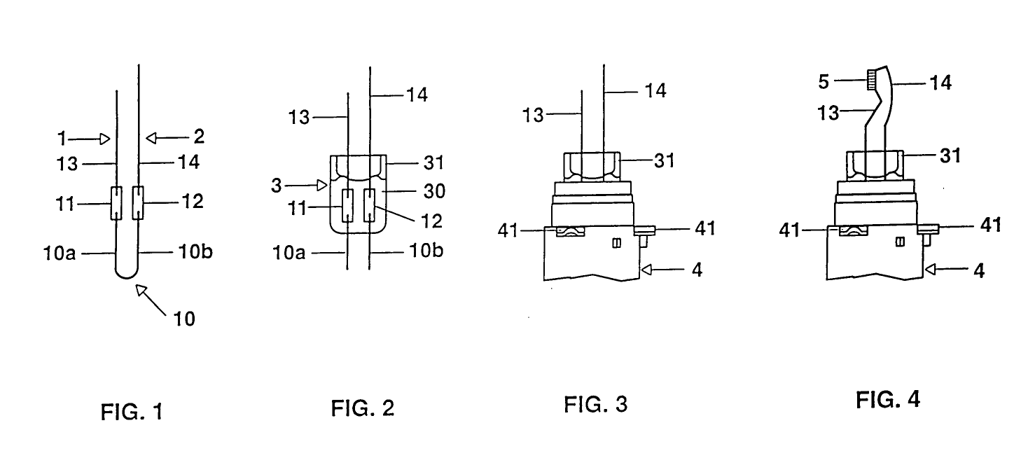

FIG. 1 shows the power supply lines for the incandescent filament of the lamp according to the preferred exemplary embodiment,

FIG. 2 shows the glass/metal composite acting as the lamp vessel seal having the power supply lines from FIG. 1 embedded therein,

FIG. 3 shows the glass/metal composite fixed in the lamp base,

FIG. 4 shows the glass/metal composite fixed in the lamp base following mounting of the incandescent filament,

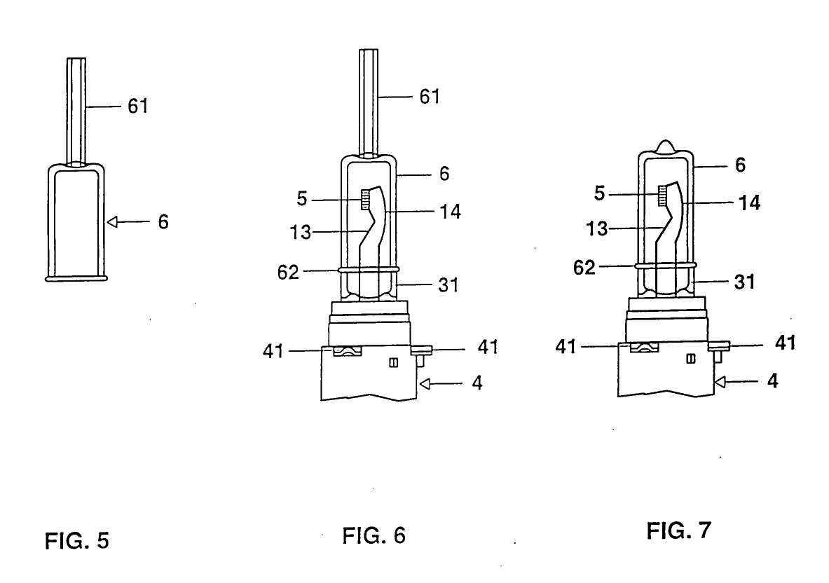

FIG. 5 shows the lamp vessel of the lamp according to the preferred exemplary embodiment,

FIG. 6 shows the unit depicted in FIG. 4 following mounting of the lamp vessel shown in FIG. 5,

FIG. 7 shows the complete lamp following sealing and removal of the exhaust tube,

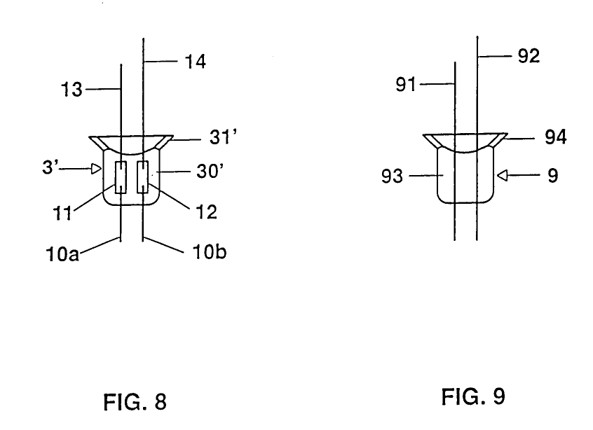

FIG. 8 shows a first alternative embodiment for the glass/metal composite illustrated in FIG. 2, and

FIG. 9 shows a second alternative embodiment for the glass/metal composite illustrated in FIG. 2.

FIGS. 1 to 7 illustrate the production method according to the invention with reference to the production of a halogen incandescent lamp for a motor vehicle headlight. FIG. 1 shows the design of the power supply lines 1, 2 of the halogen incandescent lamp. The power supply lines 1, 2 of the halogen incandescent lamp are produced from a U-shaped molybdenum wire 10, two molybdenum foils 11, 12 and two further, straight molybdenum wires 13, 14 having a different length. The two ends of the U-shaped molybdenum wire 10 are each welded to one of the two molybdenum foils 11 and 12, respectively. In each case one end of the metal wires 13, 14 is welded to one of the two molybdenum foils 11 and 12, respectively. The two straight metal wires 13, 14 form the inner part of the power supply lines 1 and 2, respectively, running inside the lamp vessel, whereas the two limbs of the U-shaped metal wire 10 form the outer part of the power supply lines 1 and 2, respectively, running outside the lamp vessel. The connection between the two U limbs 10a, 10b of the U-shaped molybdenum wire 10 is broken before the lamp is connected to the base, i.e. the domed connection region is removed by means of a cutting tool. The frame depicted in FIG. 1 which comprises the two power supply lines 1, 2 is inserted in a silica-glass tube, such that the free ends of the two straight molybdenum wires 13, 14 protrude from one end of the silica-glass tube, and the U-shaped molybdenum wire protrudes from the other end of the silica-glass tube. The silica-glass tube is heated to its softening temperature in the region of the molybdenum foils 11, 12, and, by means of pinch jaws, the softened silica glass is pressed against the molybdenum foils 11, 12 in order to seal the molybdenum foils 11, 12 into the silica glass in a gas-tight manner. The glass/metal composite 3, depicted in FIG. 2 and produced in this manner, acts as the lamp vessel seal. The molybdenum foils 11, 12 are embedded in a gas-tight manner in the sealing region 30 of the glass/metal composite 3. The two molybdenum wires 13, 14 protrude from the tubular attachment 31 of the glass/metal composite 3. The U-shaped molybdenum wire 10 protrudes from the sealing region 30. Since the frame comprising the power supply lines 1, 2 is now completely fixed by the silica glass of the glass/metal composite 3, and sufficient mechanical robustness is provided, the U-shaped molybdenum wire 10, as has already been explained above, can now be separated. The sealing region 30 of the glass/metal composite 3 depicted in FIG. 2 is then inserted in the prefabricated lamp base 4 of the halogen incandescent lamp and fixed by means of a clamping fit (FIG. 3). The lamp base 4 has three reference tabs 41 lying in a common plane which extend perpendicular to the lamp axis A-A and are arranged equidistantly along the circumference of the lamp base 4. These reference tabs 41 define a reference plane for the adjustment of the incandescent filament 5. For the purpose of adjusting and mounting the incandescent filament 5, the free ends of the molybdenum wires 13, 14 are then formed such that the incandescent filament 5 is aligned axially once its ends have been welded to the ends of the molybdenum wires 13, 14. When the incandescent filament 5 is welded to the ends of the molybdenum wires 13, 14, the position of the incandescent filament with respect to the reference tabs 41 is adjusted within predetermined tolerances (FIG. 4). The prefabricated lamp vessel 6 depicted in FIG. 5 is in the form of a circular cylinder and has an open first end and a second end, from which an exhaust tube 61 protrudes.

For the purpose of manufacturing the lamp vessel 6, a silica-glass tube was likewise used which has the same inner and outer diameter as the silica-glass tube from which the glass/metal composite 3 was produced. Following mounting of the incandescent filament 5, the prefabricated, cylindrical and hood-like lamp vessel 6 depicted in FIG. 5 is turned up over the incandescent filament 5 and its power supply lines, with the result that the open first end of the lamp vessel 6 rests on the tubular attachment 31 of the glass/metal composite 3. The open first end of the prefabricated lamp vessel 6, which has the same inner and outer diameter as the tubular attachment 31 of the glass/metal composite 3, is fused by means of a laser to the tubular attachment 31 of the glass/metal composite 3. During this fusing process, a bead 62 which surrounds the lamp vessel 6 in annular fashion is formed in the connection region between the lamp vessel 6 and the tubular attachment 31 (FIG. 6). By means of the exhaust tube 61 which is still open, the interior of the lamp vessel 6 is evacuated and filled with a noble gas or a noble gas mixture, for example krypton and/or xenon, and a halogen additive. The exhaust tube 61 is then sealed off and shortened in the vicinity of the lamp vessel 6 (FIG. 7). Its U limb is welded to the electrical contacts of the lamp base 4 in the conventional manner once the U-shaped molybdenum wire 10 has been separated.

FIG. 8 shows a schematic illustration of a first alternative embodiment of a glass/metal composite 3′ which can be used in place of the glass/metal composite 3, depicted in FIG. 2, as the lamp vessel seal for the lamp vessel 6. The glass/metal composite 3′ shown in FIG. 8 differs from the glass/metal composite 3 depicted in FIG. 2 only by the fact that the tubular attachment 31′ is widened conically. In all other features, the glass/metal composite 3′ corresponds to the glass/metal composite 3. The same reference numerals have therefore also been used in FIGS. 2 and 8 for identical components. For the purpose of manufacturing the glass/metal composite 3′, a silica-glass tube is used which has a smaller inner and outer diameter than the lamp vessel 6. In order to make it possible to fuse the lamp vessel 6 to the tubular attachment 31′, the tubular attachment 31′ is therefore widened conically prior to fusing. This glass/metal composite 3′ has the advantage over the glass/metal composite 3 that the connection point, i.e. the bead 62, is arranged closer to the sealing region 30′ and thus closer to the lamp base 4 and at a greater distance from the incandescent filament 5 than when the glass/metal composite 3 depicted in FIG. 2 is used. As a result, light scattering on the bead 62 is reduced. Light scattering on the bead 62 may also be prevented by means of a light-absorbing coating of the bead 62 or by hiding the bead 62 in the interior of the lamp base 4. In the case of lamps, such as, for example vehicle headlights, whose lamp bulbs have a light-absorbing coating on the dome facing away from the lamp base 4, the bead 62 may also be arranged in the region of the dome of the lamp bulb, with the result that the bead 62 is hidden by the light-absorbing coating. In this case, the hood-like lamp vessel 6 merely comprises the dome provided with the exhaust tube 61, and the tubular attachment 31 surrounds the incandescent filament 5 and virtually forms the entire cylindrical part of the lamp bulb.

FIG. 9 shows a second alternative embodiment of a glass/metal composite 9 which can be used in place of the glass/metal composite 3 illustrated in FIG. 2 as the lamp vessel seal. This glass/metal composite 9 comprises two molybdenum wires 91, 92 which are embedded in a gas-tight manner in a hard glass, for example aluminosilicate glass or borosilicate glass, with the result that both ends of each molybdenum wire 91, 92 protrude from the hard glass. For the purpose of producing this glass/metal composite 9, the two molybdenum wires 91, 92 are threaded through a hard-glass tube, and the hard-glass tube is heated in the sealing region 93 to its softening temperature in order to press the softened hard glass against the molybdenum wires 91, 92 by means of pinch jaws. Once the glass has cooled, the molybdenum wires 91, 92 are embedded in a gas-tight manner in the sealing region 93. The glass/metal composite 9 has, at one end, a conically widened, tubular attachment 94 which is provided for the purpose of fusing it to the lamp vessel 6. This glass/metal composite 9 may be used for lamps whose lamp vessel seal is subjected to only a comparatively low thermal load during lamp operation. For lamps having lamp vessel seals which are subjected to a high thermal load during operation, the glass/metal composites 3, 3′, made of silica glass and illustrated in FIG. 2 or 8, are used. The lamp vessel seals 3, 3′ and 9 may in each case be fused to both a silica-glass lamp vessel 6 and to a hard-glass lamp vessel. The selection of the glass for the lamp vessel 6 and for the glass/metal composite 3, 3′, 9 acting as the lamp vessel seal depends on the thermal load on the lamp vessel and the lamp vessel seal during lamp operation.

The invention is not restricted to the above-described exemplary embodiments, but may also be used, by way of example, for other types of lamp, for example discharge lamps. In addition, when the lamp vessel is evacuated and the filling components are introduced into the lamp vessel, an exhaust tube may be dispensed with when these manufacturing steps are carried out, for example, in the interior of a glove box under a protective gas atmosphere.

1. A method for producing an electric lamp, which has at least one luminous element, power supply lines for the at least one luminous element, and a lamp vessel provided with a lamp vessel seal,
wherein during the production method, a prefabricated glass/metal composite acting as the lamp vessel seal is provided, from which the power supply lines for the at least one luminous element protrude, the at least one luminous element being connected to its power supply lines during a first method step, and the lamp vessel being turned up over the at least one luminous element and connected to the glass/metal composite during a second method step following the first method step.

2. The method as claimed in claim 1, wherein the lamp vessel is fused to the glass/metal composite.

3. The method as claimed in claim 2, wherein fusing takes place by means of a LASER.

4. The method as claimed in claim 1, wherein the glass/metal composite is produced from a glass tube by the metallic power supply lines being passed through the glass tube, and then a section of the glass tube being softened by heating, and the power supply lines being embedded in the glass by pinching the softened glass.

5. The method as claimed in claim 1, wherein at least the connection region between the glass/metal composite and the lamp vessel is subjected to heat treatment for the purpose of reducing mechanical stresses.

6. The method as claimed in claim 1, wherein, when the glass/metal composite is produced, one end of the glass/metal composite is provided with a tubular attachment which is provided for connection to the lamp vessel.

7. The method as claimed in claim 6, wherein the tubular attachment is widened conically for connection to the lamp vessel.

8. The method as claimed in claim 1, wherein, before the first method step, a lamp base part acting as the reference for the adjustment of the at least one luminous element of the lamp is mounted on the glass/metal composite, and, during the first method step, the at least one luminous element is aligned with respect to the lamp base part.

9. An electric lamp having at least one luminous element which is surrounded by a lamp vessel, the lamp vessel being provided with a lamp vessel seal, through which power supply lines for the at least one luminous element are passed,
wherein the lamp vessel and the lamp vessel seal are formed as separate components which are joined by connection means.

10. The electric lamp as claimed in claim 9, wherein the lamp vessel seal has a tubular attachment which is joined to the lamp vessel by the connection means.

11. The electric lamp as claimed in claim 9, wherein the connection means is a fused connection.

12. The electric lamp as claimed in claim 9, wherein the lamp vessel seal is in the form of a pinch seal.

13. The electric lamp as claimed in claim 12, wherein the lamp vessel seal comprises metal foil embedding in silica glass, the metal foils embedded in the silica glass being part of the power supply lines.

14. The electric lamp as claimed in claim 12, wherein the lamp vessel seal comprises metal wire embedding in hard glass, the metal wires embedded in the hard glass being part of the power supply lines.

15. The electric lamp as claimed in claim 12, wherein the pinch seal is fixed in a lamp base.

16. The method as claimed in claim 2, wherein, when the glass/metal composite is produced, one end of the glass/metal composite is provided with a tubular attachment which is provided for connection to the lamp vessel.

17. The method as claimed in claim 3, wherein, when the glass/metal composite is produced, one end of the glass/metal composite is provided with a tubular attachment which is provided for connection to the lamp vessel.

18. The method as claimed in claim 4, wherein, when the glass/metal composite is produced, one end of the glass/metal composite is provided with a tubular attachment which is provided for connection to the lamp vessel.

19. The method as claimed in claim 4, wherein, before the first method step, a lamp base part acting as the reference for the adjustment of the at least one luminous element of the lamp is mounted on the glass/metal composite, and, during the first method step, the at least one luminous element is aligned with respect to the lamp base part.

20. The method as claimed in claim 6, wherein, before the first method step, a lamp base part acting as the reference for the adjustment of the at least one luminous element of the lamp is mounted on the glass/metal composite, and, during the first method step, the at least one luminous element is aligned with respect to the lamp base part.
